(19) United States
(12) Patent Application Publication
(10) Pub. No.: US 2021/0008464 A1
(43) Pub. Date: Jan. 14, 2021

(54) SPACECRAFT ATMOSPHERE CO2 CAPTURE VIA DEPOSITION

(71) Applicant: United States of America as Represented by the Administrator of NASA, Washington, DC (US)

(72) Inventors: Grace Ann BELANCIK, Santa Clara, CA (US); Roger Zhen HUANG, Redwood City, CA (US); Darrell Leslie JAN, Mountain View, CA (US)

(21) Appl. No.: 16/923,050

(22) Filed: Jul. 7, 2020

Related U.S. Application Data
(60) Provisional application No. 62/871,684, filed on Jul. 8, 2019.

(51) Int. Cl. B01D 7/02; C01B 32/55; B64G 1/48

(52) U.S. Cl. CPC B01D 7/02; F24F 2110/70; B64G 1/48; C01B 32/55

(57) ABSTRACT

A system for spacecraft atmosphere CO₂ capture that has a first heat exchanger configured to receive airflow from the spacecraft atmosphere and to cool the airflow via a first heat exchange with CO₂-depleted air. The system further has a pre-cooler configured to receive and cool the airflow from the first heat exchanger, and has a second heat exchanger configured to receive the airflow from the pre-cooler. The second heat exchanger can cool the airflow via a second heat exchange with the CO₂-depleted air. Deposition coolers can operate in a deposition mode in which CO₂ from the airflow is deposited to generate said CO₂-depleted air, and a sublimation mode in which deposited CO₂ is sublimated into CO₂ gas. A controller is configured to alternately cycle each of the first and second deposition coolers between the deposition mode and the sublimation mode.

### CROSS-REFERENCE TO RELATED APPLICATIONS

This application claims priority under 35 U.S.C. §§ 119 and 120 and 37 CFR 1.78(a) from U.S. Provisional Pat. App. No. 62/871,684 filed on Jul. 8, 2019, the contents of which are incorporated herein by reference in their entirety.

### ORIGIN OF THE INVENTION

The invention described herein was made in the performance of work under a NASA contract and by (an) employee(s) of the United States Government and is subject to the provisions of Public Law 96-517 (35 U.S.C. § 202) and may be manufactured and used by or for the Government for governmental purposes without the payment of any royalties thereon or therefore. In accordance with 35 U.S.C. § 202, the contractor has elected not to retain title.

### TECHNICAL FIELD

The present disclosure relates generally to capturing CO₂ from spacecraft crew cabin atmosphere for life support purposes.

### BACKGROUND

The goal of the National Aeronautics and Space Administration (NASA) is to return humans to the surface of the moon, then journey to Mars and even beyond. In order to accomplish this ambitious goal, robust life support systems are required to operate without reliance on a resupply. The current air revitalization system on the International Space Station (ISS), the Carbon Dioxide Removal Assembly (CDRA), utilizes sorbent-based, temperature-swing adsorption (TSA) technology. However, CDRA has repeated replacement and maintenance costs due to adsorbent material degradation.

### OVERVIEW

The instant disclosure relates to CO₂ removal systems to succeed CDRA. Specifically, it involves forcing a phase change of CO₂ from the cabin atmosphere by solidifying it onto a cold surface. Generating a cold surface can be accomplished via multiple methods, including cryogenic coolers and thermal radiators to deep space. CO₂ deposition, or CDep, is highly reliable as it has no expendable materials, no vacuum is required, and needs minimal moving parts. CDep also potentially eliminates the need for a separate storage system to deliver pressurized, pure CO₂ to an O₂ generation system, such as the Sabatier processor currently on the ISS. A deposition system can also remove residual humidity in addition to CO₂ via a multi-stage process, and can also significantly assist the trace contaminant control function. Whereas cryogenic cooling technologies are established and approaches for Mars atmosphere CO₂ capture have been tested, there is a need for the application of cryogenic cooling to capturing CO₂ from the crew cabin atmosphere for life support purposes and for systems that improve both the scale and complexity by incorporating multiple coolers that operate in parallel, alternating fashion to provide constant CO₂ capture.

Described herein a system for spacecraft atmosphere CO₂ capture includes a first heat exchanger configured to receive airflow from the spacecraft atmosphere and to cool said airflow via a first heat exchange with CO₂-depleted air, a pre-cooler configured to receive and cool the airflow from the first heat exchanger, a second heat exchanger configured to receive the airflow from the pre-cooler and to cool said airflow via a second heat exchange with the CO₂-depleted air, and first and second deposition coolers each configured to operate in a deposition mode in which CO₂ from the airflow is deposited to generate said CO₂-depleted air, and a sublimation mode in which deposited CO₂ is sublimated into CO₂ gas. A controller is configured to alternately cycle each of the first and second deposition coolers between the deposition mode and the sublimation mode, with the first cooler operating in deposition mode when the second cooler is operating in sublimation mode, and vice versa.

Also described herein is a method for spacecraft atmosphere CO₂ capture, including cooling airflow from the spacecraft atmosphere in a first heat exchange with CO₂-depleted air, cooling the airflow from the spacecraft atmosphere using a pre-cooler, cooling the airflow from the spacecraft atmosphere in a second heat exchange with the CO₂-depleted air, and depositing CO₂ from the airflow in first and second deposition coolers that are each alternately cycled between a deposition mode and a sublimation mode. In the deposition mode, CO₂ from the airflow is deposited to generate the CO₂-depleted air, and in the sublimation mode, deposited CO₂ is sublimated into CO₂ gas. When the first cooler is operating in deposition mode, the second cooler is operating in sublimation mode, and vice versa.

Also described herein is a machine-readable storage medium having stored thereon a computer program for controlling a system for spacecraft atmosphere CO2 capture, the computer program comprising a routine of set instructions for causing the system to perform the steps of cooling airflow from the spacecraft atmosphere in a first heat exchange with CO₂-depleted air, cooling the airflow from the spacecraft atmosphere using a pre-cooler, cooling the airflow from the spacecraft atmosphere in a second heat exchange with the CO₂-depleted air, and depositing CO₂ from the airflow in first and second deposition coolers that are each alternately cycled between a deposition mode and a sublimation mode. In the deposition mode, CO₂ from the airflow is deposited to generate the CO₂-depleted air, and in the sublimation mode, deposited CO₂ is sublimated into CO₂ gas. When the first cooler is operating in deposition mode, the second cooler is operating in sublimation mode, and vice versa.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a block diagram of a spacecraft atmosphere CO₂ capture system in accordance with certain embodiments;

FIG. 2 is a detailed view of cooler in accordance with certain embodiments;

FIG. 3 is a detailed view of two finhead configuration options in accordance with certain embodiments;

FIG. 4 is a flow diagram of a method of operation of system in accordance with certain embodiments;

and

FIG. 5 is a flow diagram of a method for spacecraft atmosphere CO₂ capture in accordance with certain embodiments.

### DESCRIPTION OF EXAMPLE EMBODIMENTS

Example embodiments are described herein in the context of a spacecraft atmosphere CO₂ capture system and method. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

In the description of example embodiments that follows, references to “one embodiment,” “an embodiment,” “an example embodiment,” “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. Devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

Herein, reference to a computer-readable or machine-readable storage medium encompasses one or more non-transitory, tangible storage media possessing structure. As an example and not by way of limitation, a computer-readable storage medium may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, nonvolatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The basis of the phase change method of CO₂ capture as described herein involves flowing cabin air through a chamber containing a cold surface that is below the deposition temperature of CO₂, but above the condensation points of N₂ and O₂, allowing the CO₂ to deposit. The CO₂-free air then re-enters the cabin. Once the cold surface is considered saturated with solid CO₂, the system switches to a parallel chamber. The solid CO₂ in the first chamber then sublimes and is removed for storage or for use in other processes, such as Sabatier or other process for O₂ regeneration for example.

The ISS is currently maintained at an average CO₂ partial pressure of 3.0 mmHg, but an even lower partial pressure of 2.0 mmHg, or approximately 2600 ppm assuming atmospheric pressure, will be required to maintain crew health on future missions. Also, for a 4-crew mission, the CO₂ removal system must remove 4.16 kg of CO₂ per day.

Multiple operating parameters dictate the CDep design. The first consideration is temperature. Utilizing the Clausius-Clapeyron equation and known conditions at the triple point, the deposition temperature can be estimated for any CO₂ partial pressure. At a partial pressure of 2.0 mmHg, the deposition temperature of CO₂ is about 142K. If a lower partial pressure is desired, then the deposition temperature decreases. Therefore, the operating temperature of the cold surface must be below this deposition temperature in order to both reduce the CO₂ partial pressure as well as overcome heat transfer effects to allow CO₂ to deposit.

When using a Stirling cooler, the surface temperature is dictated by the cooling power. A Stirling cooler operates by using a piston and displacer to repeatedly compress and expand a working fluid, typically helium, across two heat exchangers and a regenerator. This cycle generates a temperature gradient, therefore producing a cold surface. As the desired operating temperature increases, so does the amount of cooling power generated (at the same input electrical power). However, to generate the amount of cooling power required to directly collect 4.16 kg CO₂ per day, about ten times the current electrical power used to run CDRA would be needed. To mitigate this discrepancy, methods to increase thermal efficiency must be employed. CDep utilizes the cooled, CO₂-free air exiting the system to precool incoming air via air-to-air heat exchangers (HXs). HXs with sufficient effectiveness would reduce the electrical power needed to be equivalent to CDRA.

The second parameter that affects the system design is pressure drop. As the mass of solid CO₂ accumulates onto the cold surface, the pressure drop across the chamber is expected to increase slowly. If CO₂ ice buildup chokes the flow, then pressure increases exponentially. This change in rate of pressure drop increase may have a strong influence on cycle time—that is, time that one cooler is operating in deposition mode while the other is operating in sublimation mode, as detailed below.

A third operating parameter is the low thermal conductivity of the deposited CO₂, which insulates the cold surface from the inlet air stream, thus reducing the ability to collect more CO₂ over time. The decrease in CO₂ capture efficiency due to CO₂ ice buildup will also greatly influence the operating cycle time.

Another operating parameter to consider is cabin air inlet flow rate. The higher the inlet flow rate, the more CO₂ is exposed to the cold surface, but the more cooling power is required to cool the air and deposit a sufficient amount of CO₂. Therefore the amount of CO₂ captured increases, but capture efficiency decreases.

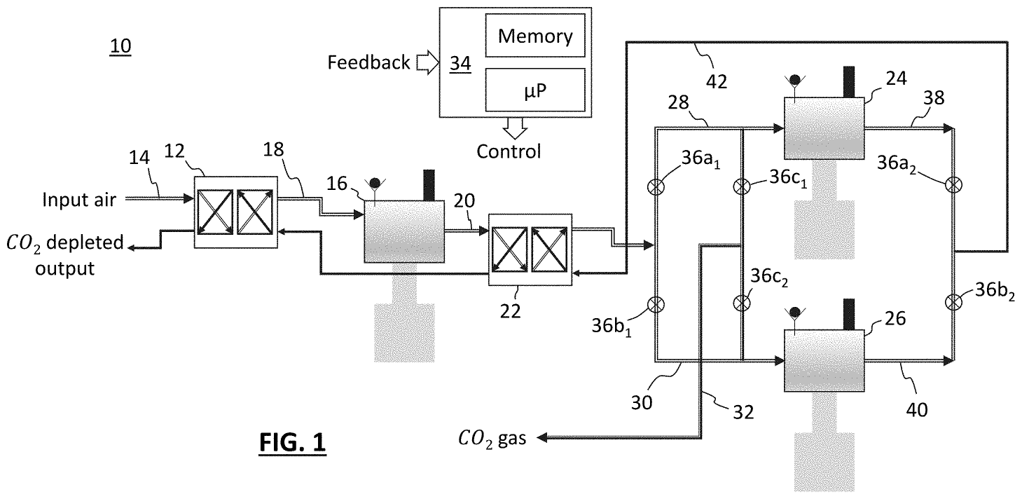

FIG. 1 is a block diagram of a spacecraft atmosphere CO₂ capture system 10 in accordance with certain embodiments. System 10 is operational for CO₂ deposition removal and may be scaled up for increased throughput for any number of crew members. The system 10 achieves deposition via a pre-cooler followed by parallel coolers in alternating operation, with the heat exchangers separated from the cooler chambers. This choice allows for simpler construction and operation and also incorporates an additional method of thermal efficiency, reducing the power requirement of the overall system. A humidity subsystem for removing water may be incorporated but is not detailed herein for simplicity.

In system 10, input cabin air at atmospheric pressure is provided to a first air-to-air heat exchanger 12 via flow path segment 14. Airflow through the system 10 can be driven by blower or similar airflow device (not shown). The flow path segment 14, as well as other segments and components described herein, are kept as short as possible to minimize thermal loss, and may be insulated, for example using Cryogel Z, which is aerogel suspended in a fiberglass blanket, and has a thermal conductivity of 0.014 W/mK. In certain embodiments, half-inch stainless steel tubing is used for air flow, and quarter inch tubing for CO₂ flow.

First heat exchanger 12 begins the cooling of the cabin air, through a heat exchange with return, CO₂-depleted air as described below. It will be appreciated that CO₂-depleted air is air from which CO₂ has been partially, completely, or substantially completely removed by the system 10. In certain embodiments, the heat exchanger 12 may be a shell-and-tube type device. Additional heat exchangers, forming multiple heat exchange stages at this or other junctures in the flow path, may be provided.

The cooled input cabin air from heat exchanger 12 is then provided to a pre-cooler 16 via flow path segment 18 for further cooling. Generally, pre-cooler 16 operates by running incoming air across a cooled surface, for example in the form of a finhead, as further detailed below. In certain embodiments, pre-cooler 16 is also configured to capture water, along with certain volatile organic compounds (VOCs), or any other compounds, trace contaminants, or the like, that may need to be removed. Such water and VOC capture can be conducted elsewhere in the flow circuit, additionally or in the alternative. In certain embodiments, pre-cooler 16 can be one of multiple pre-coolers or pre-cooler stages that can be used at this or other junctures in the flow path.

Cooled air flow from pre-cooler 16 is then directed via flow path segment 20 to a second heat exchanger 22 for additional cooling, for example to a temperature just above the CO₂ deposition temperature, by way of a heat exchange with the return CO₂-depleted air. Additional heat exchangers, forming multiple heat exchange stages at this juncture in the flow path, may be provided.

The air from second heat exchanger 22 is then alternately directed to first or second coolers 24 and 26, via respective flow path segments 28 and 30. It will be understood that coolers 24 and 26 may be referred to as deposition coolers, even though both deposition and sublimation operations may be performed by them. Like pre-cooler 16, the deposition coolers 24 and 26 operate by running incoming air across a cooled surface, for example in the form of a finhead, as further detailed below, in conditions conducive to CO₂ deposition.

The system 10 is configured to provide continuous CO₂ capture. While one of deposition coolers 24 or 26 is operating in deposition mode, the other is operating in sublimation mode, generating CO₂ gas, which is directed out of the cooler through flow path segment 32. This alternating operation of coolers 24 and 26 is managed by controller 34, which may also control flow through valves 36a₁, 36a₂, 36b₁, 36b₂, 36c₁, 36c₂ (collectively 36), opening or closing them as necessary to establish the appropriate flow streams. Thus during the deposition cycle of cooler 24 (sublimation of cycle of cooler 26), controller 34 opens valves 36a₁ and 36a₂, and closes valves 36b₁ and 36b₂, to effect flow through cooler 24 and direct CO₂-depleted return air to heat exchangers 22 and 12, by way of flow paths 28, 38 and 42. Valves 36a₁ and 36a₂, and valves 36b₁ and 36b₂, may be for example any suitable pneumatic valves. During this cycle, while cooler 24 is effecting CO₂ deposition, cooler 26 is sufficiently warmed to effect sublimation of previously-deposited CO₂, with controller 34 opening valve 36c₂ and closing valve 36c₁ to direct the sublimated CO₂ gas out through flow path 32. Valves 36c₁ and 36c₂ may be for example any suitable solenoid valves. Conversely, during the deposition cycle of cooler 26 (sublimation of cycle of cooler 24), controller 34 opens valves 36b₁ and 36b₂, and closes valves 36a₁ and 36a₂, to effect flow through cooler 26 and direct CO₂-depleted return air to heat exchangers 22 and 12, by way of flow paths 30, 40 and 42. During this cycle, while cooler 26 is effecting CO₂ deposition, cooler 24 is sufficiently warmed to effect sublimation of the previously-deposited CO₂, with controller 34 opening valve 36c₁ and closing valve 36c₂ to direct the sublimated CO₂ gas out through flow path 32. In certain embodiments, a dedicated valve controller (not shown) can be provided, and its operation can synchronized with that of controller 34 and with the cyclic operation of the coolers 24 and 26.

The durations of the deposition cycles of coolers 24 and 26 can be timer-controlled, or controlled by controller 34 as a function of feedback from various points in the system, relating to parameters such as CO₂ ice growth in the coolers 24 and 26, or CO₂ concentration in the cabin air, or any other parameters directly or indirectly affecting operation and throughput. In addition, while alternate operation of two coolers 24 and 26 is described, additional numbers of coolers can be added to the circuit and suitably synchronized to increase throughput, and some cycles may alternate completely (180 degrees) or partially.

As described herein, in certain embodiments, controller 34 includes a microprocessor (μP) executing a computer program stored in a machine-readable storage medium (memory) for controlling system 10 for spacecraft atmosphere CO₂ capture based on received feedback, the computer program comprising a routine of set instructions for causing the system to perform the steps of cooling airflow from the spacecraft atmosphere in a first heat exchange with CO₂-depleted air, cooling the airflow from the spacecraft atmosphere using a pre-cooler, cooling the airflow from the spacecraft atmosphere in a second heat exchange with the CO₂-depleted air, and depositing CO₂ from the airflow in first and second deposition coolers that are each alternately cycled between a deposition mode and a sublimation mode. In the deposition mode, CO₂ from the airflow is deposited to generate said CO₂-depleted air, and in the sublimation mode, deposited CO₂ is sublimated into CO₂ gas. When the first cooler is operating in deposition mode, the second cooler is operating in sublimation mode, and vice versa.

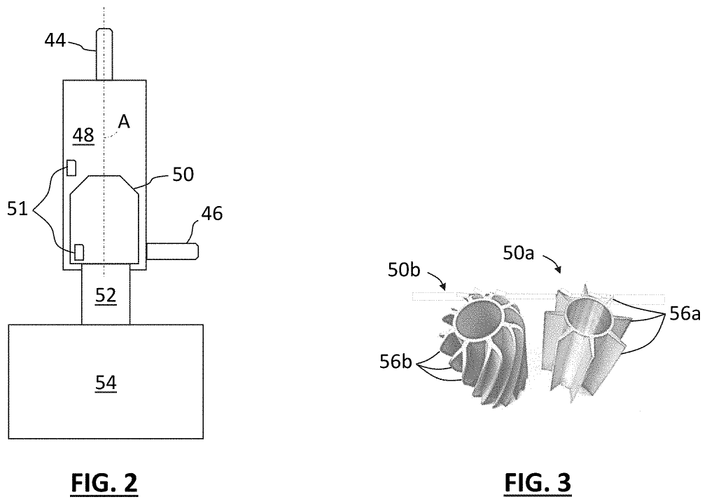

FIG. 2 shows details of cooler 24, which may be the same as coolers 16 and 26, except where noted. Cooler 24 includes flow inlet 44 and flow outlet 46, which communicate with chamber 48. Inlet 44 is coupled to path 28 (FIG. 1) for directing air flow from heat exchanger 22 to chamber 48, by way of valve 36a₁. Inlet 44 is also coupled to CO₂ output path 32, for directing sublimated CO₂ out of chamber 48 by way of valve 36c₁. Outlet 46 is coupled to path 42 for directing air flow from chamber 48 back to heat exchanger 22, by way of flow path 38 and valve 36a₂.

Chamber 48 of cooler 24 contains a finhead 50 mounted on a cold tip 52. The cold tip cools the finhead 50 to the appropriate temperate to induce deposition of CO₂ on the finhead. Cooling of the cold tip 52 can be accomplished by a cooling source 54, which can be for example a cryogenic cooler as explained below, and/or thermal radiator to deep space. Use of piston coolers and Stirling coolers is also contemplated. The cooling source 54 is precisely controllable, for example by controller 34 (FIG. 1), to bring the finhead 50 to the CO₂ deposition temperature during the deposition cycle of cooler 24, and to raise the finhead temperature to the CO₂ sublimation temperature during the sublimation cycle of the cooler 24. The other coolers 16 and 26, and any additional cooling and/or deposition/sublimation stages that may be used, can also be similarly precisely controlled for pre-cooling and/or deposition and/or sublimation by a suitable controller(s) such as controller 34, or one or more dedicated controllers (not shown). Such control can be responsive to feedback received from sensors 51, which can measure a variety of parameters in the cooler or elsewhere in the system, such as temperature, pressure, flow rate, humidity, dewpoint, CO₂ concentration, power consumption, electrical current flow, electrical voltage, and so on at different locations including for example within the chamber 48, at the finhead 50, cold tip 52, cooling source 54, valves, or any of the flow paths or electrical and mechanical devices and components.

The required cooling power of deposition cooler 24, as well as pre-cooler 16 and deposition cooler 26 at one or more crew scale, may be determined based on an energy balance calculator. Input parameters include air flow rate required to remove 1 kg CO₂/day (initial estimate of 5 Standard Cubic Feet Per Minute, “SCFM”), inlet CO₂ concentration, cold surface temperature required, estimated HX effectiveness, and CO₂ capture efficiency. In certain embodiments, for the pre-cooler 16, a Janis SC-10 provides sufficient power and can be used. For the deposition coolers 24 and 26, two Sunpower Cryotel GTs can be used. The Janis cooler is air-cooled, but the Cryotels utilize a water jacket to reject heat, so a circulating coolant loop may be supplied via a Koolance EXC-800.

In certain embodiments, the chamber 48 enclosing the cold tips and attached finheads may be manufactured by modifying ConFlat (CF) unions for the Sunpower Cryotel deposition coolers 24 and 26, and a Klein Flange union for the Janis pre-cooler 16.

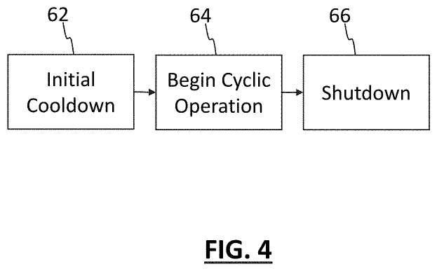

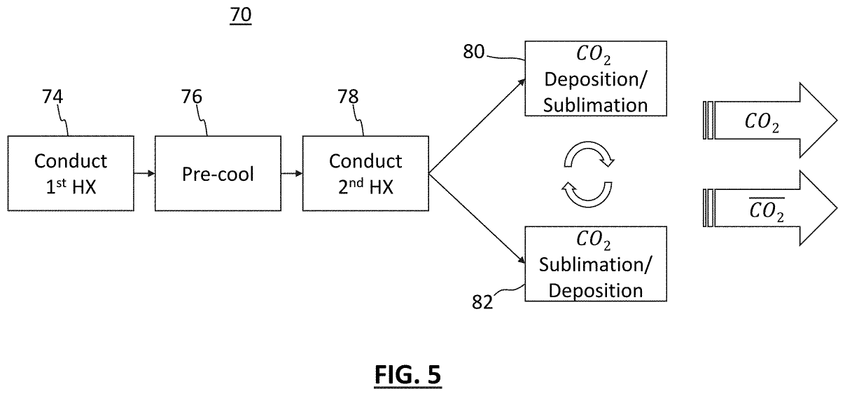

FIG. 3 shows detailed views of two finhead configuration options in accordance with certain embodiments. Each finhead 50 has a pattern of radially projecting fins 56. In the right-side configuration, finhead 50a has eight fins 56a that are straight and extend along the axis direction (A) of the finhead. In construction, the finhead 50a can be cut from copper stock and formed via wire electrical discharge machining (EDM). In the left-side configuration, the fins 56b of finhead 50b have a helical, forked form. Finhead 56b can be 3D-printed in alloy GRCop-84 via selective laser melting (SLM). Other finhead configurations are also possible, with the aim of high surface area for maximized cooling interaction with the air flow and maximized condensation of the CO₂ thereon. Reduced mass of the finhead is desired in order to reduce the amount of energy needed to cool the finhead and maintain its low temperature.

In the operation of cooler 24 in deposition mode, air flow is directed into chamber 48 in the axial direction (A) from inlet 44, and passes across the cooling of finhead 50 for cooling thereby to the CO₂ deposition temperature, depositing its CO₂ load on the finhead. The CO₂-free air is then ejected from the chamber 48, out through outlet 46. In the operation of cooler 24 in sublimation mode, finhead 50 is warmed sufficiently to cause CO₂ ice that has accumulated on the finhead 50 during the previous deposition cycle to sublimate into the chamber 48 for expulsion, motivated by pressure due to the phase change of the CO₂ from solid to gas. The density of solid CO₂ is approximately 1500 kg/cubic meter while the density of gaseous CO₂ is approximately 1.98 kg/cubic meter, yielding a volumetric expansion ratio of approximately 750:1. By selectively controlling the seal of the chamber 48 in which this expansion is occurring, pressure is allowed to build up to desired levels.

FIG. 4 is a flow diagram of a method 60 of operation of system 10 in accordance with certain embodiments. At 62, an initial cooldown procedure is performed, in which all valves are open, air is flowing, and all coolers are cooling until the deposition temperature setpoint is reached. At 64, cyclic operation begins. The valves are controlled to direct air flow to deposition cooler 24 and to prevent air flow to deposition cooler 26, while venting CO₂ gas from deposition cooler 26. After a set period of time or based on feedback considerations, the valves are controlled to direct air flow to deposition cooler 26 and to prevent air flow to deposition cooler 24, while venting CO₂ gas from deposition cooler 24. This process is repeated to maintain target CO₂ levels in the cabin atmosphere. At 66, shutdown is initiated (for example manually by the user, or by controller 34 in case of malfunction or maintenance requirements). Once shutdown is initiated, both coolers 24, 26 may be turned off and CO₂ product or other valves powered open, for example to prevent overpressure. Then, shutdown is completed.

FIG. 5 is a flow diagram of a method 70 for spacecraft atmosphere CO₂ capture in accordance with certain embodiments. At 74, following initial cooldown, airflow from the spacecraft atmosphere is cooled in a first heat exchange with CO₂-depleted air. At 76, the airflow is cooled using a pre-cooler. At 78, the airflow is cooled in a second heat exchange with the CO₂-depleted air. At 80 and 82, CO₂ from the airflow is deposited in first and second deposition coolers that are each alternately cycled between a deposition mode and a sublimation mode. In the deposition mode, CO₂ from the airflow is deposited to generate the CO₂-depleted air (C̅O̅₂̅) and CO₂ ice; and in the sublimation mode, deposited CO₂ ice is sublimated into CO₂ gas. When the first cooler is operating in deposition mode, the second cooler is operating in sublimation mode, and vice versa.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted based on the foregoing description. This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A system for spacecraft atmosphere CO₂ capture comprising:
a first heat exchanger configured to receive airflow from the spacecraft atmosphere and to cool said airflow via a first heat exchange with CO₂-depleted air;
a pre-cooler configured to receive and cool the airflow from the first heat exchanger;
a second heat exchanger configured to receive the airflow from the pre-cooler and to cool said airflow via a second heat exchange with the CO₂-depleted air;
first and second deposition coolers each configured to operate in:
a deposition mode in which CO₂ from the airflow is deposited to generate said CO₂-depleted air, and
a sublimation mode in which deposited CO₂ is sublimated into CO₂ gas; and
a controller for alternately cycling each of the first and second deposition coolers between the deposition mode and the sublimation mode, with the first deposition cooler operating in deposition mode when the second deposition cooler is operating in sublimation mode, and vice versa.

2. The system of claim 1, further comprising one or more sensors for providing feedback to the controller and wherein said cycling each of the first and second deposition coolers between the deposition mode and the sublimation mode is a function of said feedback.

3. The system of claim 2 wherein said feedback relates to one or more of temperature, pressure, flow rate, humidity, dewpoint, CO₂ concentration, CO₂ ice growth, power consumption, electrical current flow, or electrical voltage.

4. The system of claim 1, wherein each of the first and second deposition coolers comprises:
a cooling chamber for receiving the airflow;
a cooling source;
a cold tip; and
a finhead disposed in the chamber and thermally coupled to the cooling source via the cold tip for cooling the airflow in the chamber.

5. The system of claim 4, wherein the cooling source comprises a cryogenic cooler.

6. The system of claim 4, wherein the cooling source comprises a thermal radiator to deep space.

7. The system of claim 4, wherein the finhead includes a plurality of radially-projecting fins.

8. The system of claim 6, wherein the radially-projecting fins are helical.

9. A method for spacecraft atmosphere CO₂ capture comprising:
cooling airflow from the spacecraft atmosphere in a first heat exchange with CO₂-depleted air;
cooling the airflow from the spacecraft atmosphere using a pre-cooler;
cooling the airflow from the spacecraft atmosphere in a second heat exchange with the CO₂-depleted air; and
depositing CO₂ from the airflow in first and second deposition coolers that are each alternately cycled between a deposition mode and a sublimation mode, wherein, in the deposition mode, CO₂ from the airflow is deposited to generate said CO₂-depleted air, and in the sublimation mode, deposited CO₂ is sublimated into CO₂ gas,
wherein, when the first cooler is operating in deposition mode, the second cooler is operating in sublimation mode, and vice versa.

10. The method of claim 9, further comprising controlling operation of said first and second deposition coolers based on feedback relating to one or more of temperature, pressure, flow rate, humidity, CO₂ concentration, power consumption, electrical current flow, or electrical voltage.

11. The method of claim 9, wherein each of the first and second deposition coolers comprises:
a cooling chamber for receiving the airflow;
a cooling source;
a cold tip; and
a finhead disposed in the chamber and thermally coupled to the cooling source via the cold tip for cooling the airflow in the chamber.

12. The method of claim 11, wherein the cooling source comprises a cryogenic cooler.

13. The method of claim 11, wherein the cooling source comprises a thermal radiator to deep space.

14. The method of claim 11, wherein the finhead includes a plurality of radially-projecting fins.

15. The method of claim 14, wherein the radially-projecting fins are helical.

16. The method of claim 9, further comprising removing moisture, VOCs, or contaminants from the airflow.

17. A machine-readable storage medium having stored thereon a computer program for controlling a system for spacecraft atmosphere CO₂ capture, the computer program comprising a routine of set instructions for causing the system to perform the steps of:
cooling airflow from the spacecraft atmosphere in a first heat exchange with CO₂-depleted air;
cooling the airflow from the spacecraft atmosphere using a pre-cooler;
cooling the airflow from the spacecraft atmosphere in a second heat exchange with the CO₂-depleted air; and
depositing CO₂ from the airflow in first and second deposition coolers that are each alternately cycled between a deposition mode and a sublimation mode, wherein, in the deposition mode, CO₂ from the airflow is deposited to generate said CO₂-depleted air, and in the sublimation mode, deposited CO₂ is sublimated into CO₂ gas,
wherein, when the first cooler is operating in deposition mode, the second cooler is operating in sublimation mode, and vice versa.

18. The machine-readable storage medium of claim 17, wherein the routine of set instructions further cause the system to perform the step of controlling operation of said first and second deposition coolers based on feedback relating to one or more of temperature, pressure, flow rate, humidity, dewpoint, CO₂ concentration, power consumption, electrical current flow, or electrical voltage.

19. The machine-readable storage medium of claim 17, wherein at least one of the first or second deposition coolers comprises a thermal radiator to deep space.

20. The machine-readable storage medium of claim 17, wherein the routine of set instructions further cause the system to perform the step of removing moisture, VOCs, or contaminants from the airflow.
